(19) United States
(12) Patent Application Publication
(10) Pub. No.: US 2008/0225320 A1
(43) Pub. Date: Sep. 18, 2008

(54) SYSTEMS AND METHODS FOR UNIFIED IMAGING JOB ACCOUNTING

(75) Inventor: Andrew Rodney Ferlitsch, Camas, WA (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc., Camas, WA (US)

(21) Appl. No.: 11/685,062

(22) Filed: Mar. 12, 2007

(51) Int. Cl. G06F 3/01

(52) U.S. Cl. 358/1.13

(57) ABSTRACT

A method for unified imaging job accounting may involve determining one or more imaging operations that are performed as part of processing the imaging job. The method may also involve determining standard rates that are defined for the one or more imaging operations. The standard rates may be applied across multiple imaging jobs that are processed by the imaging device. The method may also involve determining charges to be applied for the imaging job based on the one or more imaging operations that are performed as part of processing the imaging job and also based on the standard rates that are defined for the one or more imaging operations. The method may also involve applying the charges that are determined for the imaging job.

### TECHNICAL FIELD

The present disclosure relates generally to computers and computer-related technology. More specifically, the present disclosure relates to imaging devices and document imaging.

### BACKGROUND

“Imaging,” as the term is used herein, refers to one or more of the processes involved in the display and/or printing of graphics and/or text. The term “imaging device,” as used herein, refers to any electronic device that provides functionality related to imaging. Some examples of imaging devices include multi-function peripheral devices, printers, copiers, scanners, facsimile devices, document servers, image servers, electronic whiteboards, digital cameras, digital projection systems, medical imaging devices, and so forth.

For various reasons, an imaging device may be logically connected to (i.e., placed in electronic communication with) one or more computer systems, which may be referred to as host computer systems (or simply as hosts). For example, a printer may be connected to a network of computer systems. This allows the users of the various computer systems on the network to use the printer.

Different kinds of computer software facilitate the use of imaging devices. The computer system that is used to image (e.g., print) the materials typically has one or more pieces of software that enable it to send information to the imaging device to facilitate the imaging of the materials. If the computer system is on a computer network there may be one or more pieces of software running on one or more computers on the computer network that facilitate the imaging of the materials.

As used herein, the term “imaging job” may refer to an imaging-related task that is performed by an imaging device. An example of an imaging job is a print job, which may be a single document or a set of documents that is submitted to a printer for printing. Imaging jobs such as copying, scanning, and the like may be referred to as walkup imaging jobs (or simply as walkup jobs).

In certain computing environments, it may be desirable to track information that relates to imaging jobs that are processed by an imaging device. The information that is tracked may be used for a variety of reasons. Tracking information related to each imaging job may be referred to herein as imaging job accounting. The present disclosure relates to imaging job accounting for imaging jobs that are processed by an imaging device.

### BRIEF DESCRIPTION OF THE DRAWINGS

FIG. 1 illustrates a system for unified imaging job accounting in accordance with an embodiment;

FIG. 2 illustrates the operation of a job accounting system in accordance with an embodiment in response to the initiation of an imaging job;

FIG. 3 illustrates the operation of a job accounting system in accordance with an embodiment in response to a format translation operation being performed on an electronic document as part of an imaging job;

FIG. 4 illustrates the operation of a job accounting system in accordance with an embodiment in response to a rasterization operation being performed on a converted document as part of an imaging job;

FIG. 5 illustrates the operation of a job accounting system in accordance with an embodiment in response to an outputting operation being performed on a rasterized document as part of an imaging job;

FIG. 6 illustrates the operation of a job accounting system in accordance with an embodiment in response to an imaging job that involves performing at least one imaging operation on a hard copy document;

FIG. 7 illustrates an example showing how a job accounting system may process multiple imaging jobs in accordance with an embodiment;

FIG. 8 illustrates another exemplary operating environment in which embodiments may be practiced;

FIG. 9 illustrates a method for unified imaging job accounting in accordance with an embodiment; and

FIG. 10 illustrates various components that may be utilized in a computing device.

### DETAILED DESCRIPTION

A method for unified imaging job accounting is disclosed. The method may be implemented by a job accounting system. The method may involve determining one or more imaging operations that are performed as part of processing the imaging job. The method may also involve determining standard rates that are defined for the one or more imaging operations. The standard rates may be applied across multiple imaging jobs that are processed by the imaging device independent of imaging job type. The method may also involve determining charges to be applied for the imaging job based on the one or more imaging operations that are performed as part of processing the imaging job and also based on the standard rates that are defined for the one or more imaging operations. The method may also involve applying the charges that are determined for the imaging job.

A separate standard rate may be defined for each of the one or more imaging operations. A separate charge may be applied for each imaging operation that is performed as part of processing the imaging job.

The method may be performed for each imaging job of a plurality of imaging jobs that are processed by the imaging device. Different charges may be applied for different imaging jobs of the same type and same job settings if the different imaging jobs comprise different imaging operations.

Applying the charges for the imaging job may involve recording the charges in an accounting record that is uniquely associated with the imaging job. The imaging job may include a reference to the accounting record that has been created for that imaging job.

All of the one or more imaging operations may be performed by the imaging device. Alternatively, at least one of the one or more imaging operations may be performed by a service that is external to the imaging device.

The one or more imaging operations may include a format translation operation. The one or more imaging operations may include a rasterization operation. The one or more imaging operations may include an outputting operation. The one or more imaging operations may include a scanning operation.

At least one of the one or more imaging operations of the imaging job may be performed on an electronic document. At least one of the one or more imaging operations of the imaging job may be performed on a hard copy document. The method may involve not applying any charges for any of the one or more imaging operations that are performed by a user's resources.

The job accounting system may be part of the imaging device. Alternatively, or in addition, the job accounting system may be external to the imaging device.

A computer system that is configured for unified imaging job accounting is disclosed. The computer system includes a processor and memory in electronic communication with the processor. Instructions are stored in the memory. The instructions may be executable to determine one or more imaging operations that are performed as part of processing the imaging job. The instructions may also be executable to determine standard rates that are defined for the one or more imaging operations. The standard rates may be applied across multiple imaging jobs that are processed by the imaging device independent of imaging job type. The instructions may also be executable to determine charges to be applied for the imaging job based on the one or more imaging operations that are performed as part of processing the imaging job and also based on the standard rates that are defined for the one or more imaging operations. The instructions may also be executable to apply the charges that are determined for the imaging job.

A computer-readable medium is disclosed. The computer-readable medium may include executable instructions for determining one or more imaging operations that are performed as part of processing the imaging job. The computer-readable medium may also include executable instructions for determining standard rates that are defined for the one or more imaging operations. The standard rates may be applied across multiple imaging jobs that are processed by the imaging device independent of imaging job type. The computer-readable medium may also include executable instructions for determining charges to be applied for the imaging job based on the one or more imaging operations that are performed as part of processing the imaging job and also based on the standard rates that are defined for the one or more imaging operations. The computer-readable medium may also include executable instructions for applying the charges that are determined for the imaging job.

Several exemplary embodiments are now described with reference to the Figures. This detailed description of several exemplary embodiments, as illustrated in the Figures, is not intended to limit the scope of the claims.

The word “exemplary” is used exclusively herein to mean “serving as an example, instance or illustration.” Any embodiment described as “exemplary” is not necessarily to be construed as preferred or advantageous over other embodiments.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments,” unless expressly specified otherwise.

The term “determining” (and grammatical variants thereof) is used in an extremely broad sense. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

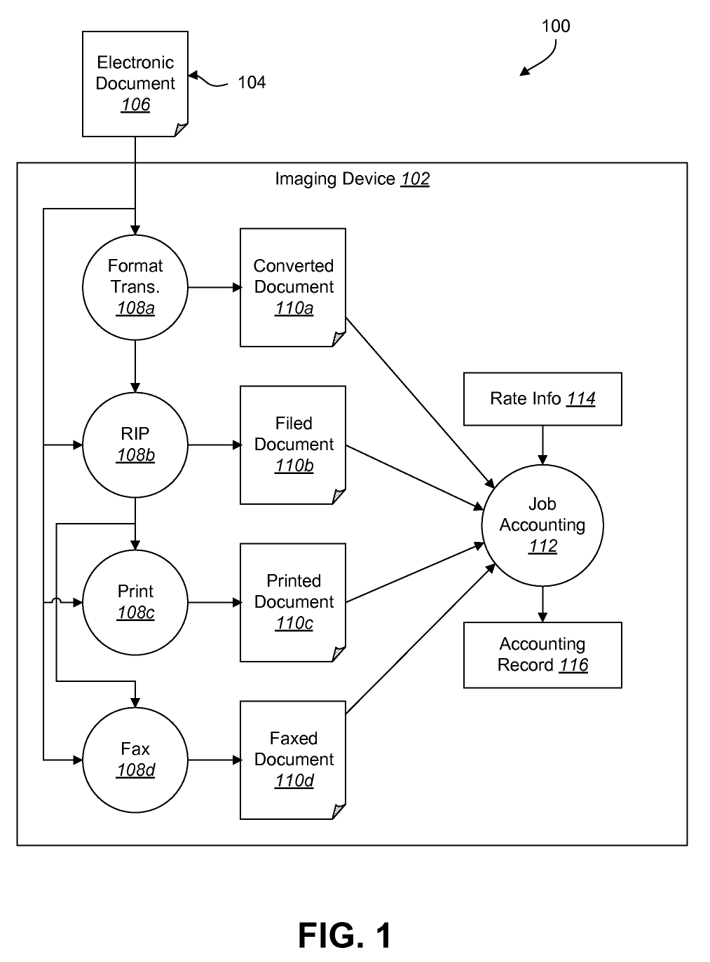

FIG. 1 illustrates an exemplary operating environment 100 in which embodiments may be practiced. The operating environment 100 includes an imaging device 102. The imaging device 102 may be an electronic device that provides functionality related to imaging. Some examples of imaging devices 102 include printers, copiers, scanners, facsimile devices, filing devices, format converters, duplication systems, document servers, image servers, electronic whiteboards, digital cameras, digital projection systems, medical imaging devices, and so forth.

The imaging device 102 may be configured to receive and process imaging jobs 104. Processing an imaging job 104 may involve performing one or more imaging operations on an electronic document 106. Alternatively, or in addition, processing an imaging job 104 may involve performing one or more imaging operations on a hardcopy document (not shown). Some examples of imaging operations include printing, copying, scanning, filing, faxing, emailing, performing format conversion, publishing, duplicating, displaying, performing optical character recognition (OCR), performing Bates stamping, bar code-related operations, storage, image enhancement, compression, encryption, watermarks, indexing/filing, document transfer, natural language translation, etc.

The imaging device 102 may include a number of imaging components that perform imaging operations on an electronic document 106 as part of processing an imaging job 104. For example, the imaging device 102 may include a format translation component 108a, a rasterization component 108b, a printing component 108c, a facsimile component 108d, etc. The imaging device 102 may be configured to perform a diverse (customizable) set of imaging jobs 104.

The format translation component 108a may be configured to perform format translation on an electronic document 106 from a pre-printer ready format (e.g., an application document) to a printer ready format (e.g., Postscript), thereby generating a converted document 110a. The rasterization component 108b may be configured to perform rasterization on an electronic document 106 that is in a printer ready format. Both the printing component 108c and the facsimile component 108d may be configured to perform an outputting operation (e.g., printing and faxing, respectively). The processing of an imaging job 104 may result in a converted document 110a, a filed document 110b, a printed document 110c, a faxed document 110d, etc.

The exemplary operating environment 100 also includes a job accounting system 112. In the depicted embodiment, the job accounting system 112 is part of the imaging device 102. Alternatively, the job accounting system 112 may be separate from the imaging device 102.

The job accounting system 112 may be configured so that each time an imaging job 104 is processed by the imaging device 102, the job accounting system 112 determines the charges that are to be applied for the imaging job 104. To determine the charges to be applied for a particular imaging job 104, the job accounting system 112 may determine the individual imaging operations (e.g., format translation, rasterization, hardcopy output, etc.) that are performed as part of processing the imaging job 104. The job accounting system 112 may also determine standard rates that are defined for the imaging operations, i.e., rates that are applied across multiple imaging jobs 104 that are processed by the imaging device 102. This rate information 114 may be stored on the job accounting system 112, or it may be stored on another system that is accessible to the job accounting system 112.

The charges that are to be applied for the imaging job 104 may be based on the individual imaging operations that are performed as part of processing the imaging job 104, and also based on the standard rates that are defined for these imaging operations. The charges for a particular imaging job 104 may include a separate charge for each imaging operation that is performed as part of processing the imaging job 104. Once the charges for an imaging job 104 have been determined, the job accounting system 112 may then apply the charges. This may involve recording the charges in an accounting record 116 that is uniquely associated with the imaging job 104.

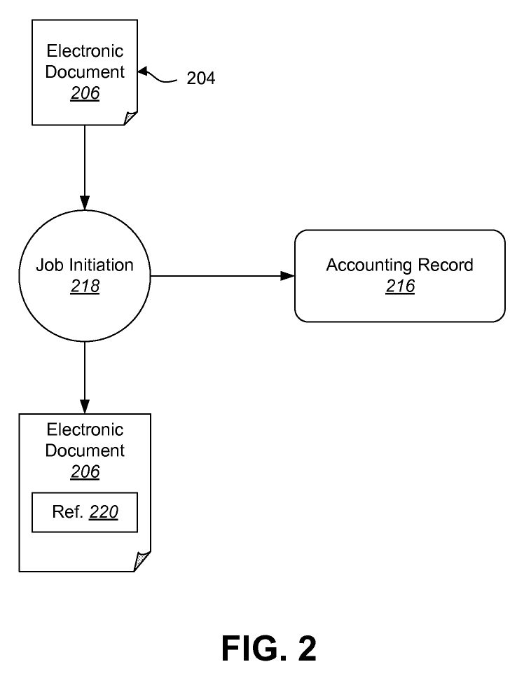

FIG. 2 illustrates the operation of a job accounting system 112 in accordance with an embodiment in response to the initiation of an imaging job 204. The imaging job 204 may be initiated as a walk-up job (e.g., the imaging job 204 may be initiated at an imaging device 102), a host-based job (e.g., the imaging job 204 may be initiated at a host computing device), a hostless job (an email/FTP printing job), etc. The imaging job 204 may be initiated by a user. As part of the initiation of the imaging job 204, the user may authenticate himself. For example, the user may log into either the imaging device 102 or the host computing device, and the user may be authenticated within the network domain. Alternatively, the user may input an accounting code for the imaging job 204.

In response to the initiation of the imaging job 204, an accounting record 216 for the imaging job 204 may be created. Creation of the accounting record 216 may occur upstream from the imaging device 102 that is processing the imaging job 204, such as at an imaging server (not shown) which may be communicatively between the job source and the imaging device 102. Alternatively, creation of the accounting record 216 may occur by the imaging device 102 or via an external service that is provided to the imaging device 102, etc. A job initiation component 218 is shown in FIG. 2.

The accounting record 216 may be uniquely associated with the imaging job 204. For example, a reference 220 to the accounting record 216 may be added to the imaging job 204 (e.g., embedded within the electronic document 206). This may be accomplished by adding a header (e.g., metadata) to the electronic document 206. Alternatively, this may be accomplished by converting the imaging job 204 into an internal representation and maintaining the accounting record 216 within the internal representation. Alternatively still, this may be accomplished by associating (e.g., cross-referencing) the accounting record 216 and the imaging job 204 based on a unique aspect of the imaging job 204 (e.g., the primary key being a job identifier).

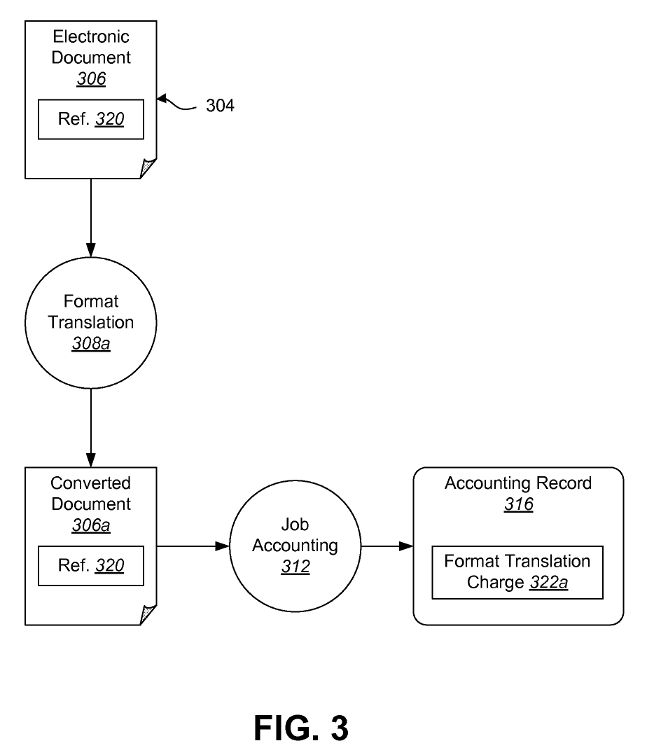

FIG. 3 illustrates the operation of a job accounting system 312 in accordance with an embodiment in response to a format translation operation being performed on an electronic document 306 as part of an imaging job 304. At some point after the imaging job 304 is initiated on an imaging device 102, the imaging device 102 may determine if the electronic document 306 is in a printer ready format (e.g., PostScript). If the electronic document 306 is not in a printer ready format (e.g., if the document 306 is in an application format, such as a Microsoft Word® document), a format translation operation may be performed on the electronic document 306. The format translation operation may involve converting 308a the electronic document 306 into a printer ready format, thereby generating a converted document 306a.

The format translation operation may be performed by a format translation service, which may be built into the imaging device 102 that is processing the imaging job 304. Alternatively, the format translation service may be external to the imaging device 102. Alternatively still, the format translation service may run as a guest service on the imaging device 102. A format translation component 308a is shown in FIG. 3.

In response to the format translation operation being performed, a format translation charge 322a may be charged to an accounting record 316 that is associated with the imaging job 304. (As shown, both the electronic document 306 and the converted document 306a may include a reference 320 to the accounting record 316.) The format translation charge 322a may be based on a standard rate that is defined for the format translation operation. This standard rate may be based on one or more factors, such as the number of pages of the electronic document 306, the size (e.g., number of bytes) of the electronic document 306, the format type, time of day, amortization of the translation service, etc.

If the imaging job 304 is completed after the format translation operation is performed, the job accounting system 312 may be configured so that the accounting record 316 is only charged the format translation charge 322a (i.e., so that no charges other than the format translation charge 322a are applied to the accounting record 316). Otherwise, the format translation charge 322a may be one charge in an accumulative series of charges.

Under some circumstances, a format translation operation may not be performed on an electronic document 306 as part of an imaging job 304. For example, the electronic document 306 may already be in a printer ready format when the imaging job 304 is initiated on the imaging device 102 (e.g., the user may convert an application document to Postscript using an application/driver installed on their computer system prior to initiating the imaging job 304). The job accounting system 312 may be configured so that no charge is made for a format translation operation if a format translation operation is not performed as part of the imaging job 304.

Also, under some circumstances, the format translation operation may be performed by the user's resources. For example, the user's computer system may host a format translation service and the imaging device 102 may be configured to utilize the user's format translation service. The job accounting system 312 may be configured so that no charge is made if the format translation operation is performed by the user's resources.

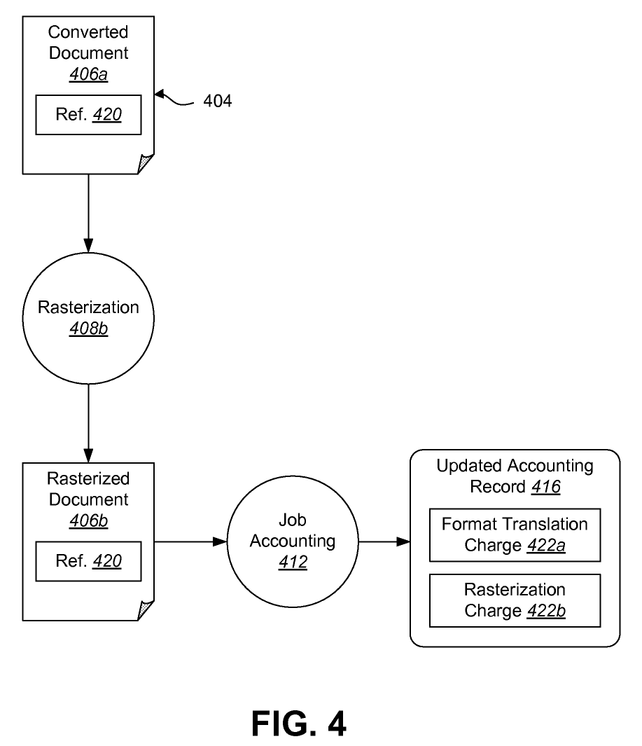

FIG. 4 illustrates the operation of a job accounting system 412 in accordance with an embodiment in response to a rasterization operation being performed on a converted document 406a as part of an imaging job 404. The converted document 406a may be the original document 306 (not shown in FIG. 4) or the converted document from the format translation service (306a). The imaging device 102 may determine if a rasterization operation is to be performed on the converted document 406a as part of processing the imaging job 404. If a rasterization operation is to be performed, then printer ready data (e.g., Postscript, PCL, PDF, TIFF, etc.) of the converted document 406a may be rasterized by the imaging device 102, thereby generating a rasterized document 406b. The rasterization operation may be performed by an internal process within the imaging device 102. Alternatively, the rasterization operation may be performed by a guest hosted process or by an external service. A rasterization component 408b is shown in FIG. 4.

In response to the rasterization operation being performed, a rasterization charge 422b may be applied to the accounting record 416 that is associated with the imaging job 404. (As shown, both the converted document 406a and the rasterized document 406b may include a reference 420 to the accounting record 416.) The rasterization charge 422b may be in addition to any charges for imaging operations that have previously been performed as part of processing the imaging job 404 (e.g., a format translation charge 422a). The rasterization charge 422b may be based on a standard rate that is defined for the rasterization operation. This standard rate may be based on one or more factors, such as the number of rasterized pages, the size (e.g., number of bytes) of the rasterized output, the PDL interpreter type, time of day, amortization of the rasterization service, etc.

If the imaging job 404 is completed after the rasterization operation is performed, the job accounting system 412 may be configured so that the accounting record 416 is only charged for the rasterization operation and any prior imaging operations that were performed (e.g., format translation). Otherwise, the rasterization charge 422b may be one additional charge in an accumulative series of charges.

Under some circumstances, a rasterization operation may not be performed on an electronic document as part of an imaging job 404. For example, an electronic document may already have been rasterized when the imaging job 404 is initiated on the imaging device 102 (e.g., the user may convert an application document to raster data using an application/raster driver installed on their computer system prior to initiating the imaging job 404). The job accounting system 412 may be configured so that no charge is made for a rasterization operation if a rasterization operation is not performed as part of the imaging job 404.

Also, under some circumstances, the format translation operation may be performed by the user's resources. For example, the user's computer system may host a rasterization service and the imaging device 102 may be configured to utilize the user's rasterization service. The job accounting system 412 may be configured so that no charge is made if the rasterization operation is performed by the user's resources.

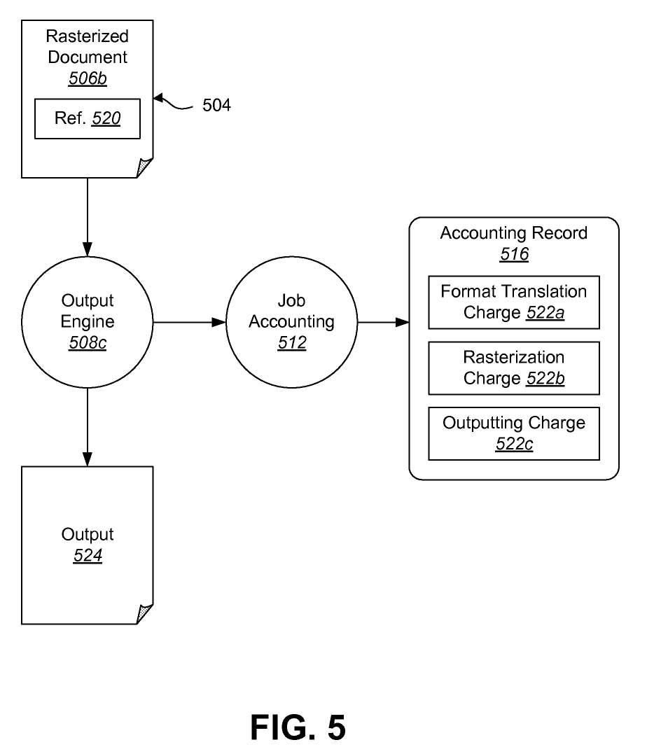

FIG. 5 illustrates the operation of a job accounting system 512 in accordance with an embodiment in response to an outputting operation being performed on a rasterized document 506b as part of an imaging job 504. The rasterized document 506b may be the original document 306 (not shown in FIG. 5) or the rasterized document from the rasterization service (406b). An imaging device 102 may determine if an outputting operation is to be performed on the rasterized document 506b as part of processing the imaging job 504. Some examples of outputting operations that may be performed include hardcopy output (e.g., printing), facsimile transmission, electronic document transfer (e.g., FTP, email, etc.). An outputting operation may be performed by an internal process in the imaging device 102, by a guest hosted process, or as an external service. An output engine 508c and the resulting output 524 are both shown in FIG. 5.

If an outputting operation is performed on the rasterized document 506b as part of processing the imaging job 504, an outputting charge 522c may be applied to an accounting record 516 that is uniquely associated with the imaging job 504. (As shown, the rasterized document 506b may include a reference 520 to the accounting record 516.) The outputting charge 522c may be based on a standard rate that is defined for the outputting operation. This standard rate may be based on one or more factors, such as the number and type of sheets or pages, the number of bytes or amount and type of toner consumed, the outputting type (e.g., print, fax, electronic transfer, etc.), finishing options (e.g., stapling, hole punch), time of day, amortization of the outputting service, etc.

If the imaging job 504 is completed after the outputting operation is performed, the job accounting system 512 may be configured so that the accounting record 516 may only be charged for the outputting operation and any prior imaging operations that were performed (e.g., a format translation charge 522a, a rasterization charge 522b, etc.). Otherwise, the outputting charge 522c may be another charge in an accumulative series of charges.

Under some circumstances, an outputting operation may not be performed on a rasterized document 506b as part of an imaging job 504. For example, the imaging job 504 may be a filing job. The job accounting system 512 may be configured so that no charge is made for an outputting operation if an outputting operation is not performed as part of the imaging job 504.

Also, under some circumstances, an outputting operation may be performed by the user's resources. For example, the user's computer system may host an outputting service and the imaging device 102 may be configured to utilize the user's outputting service. The job accounting system 512 may be configured so that no charge is made if the outputting operation is performed by the user's resources.

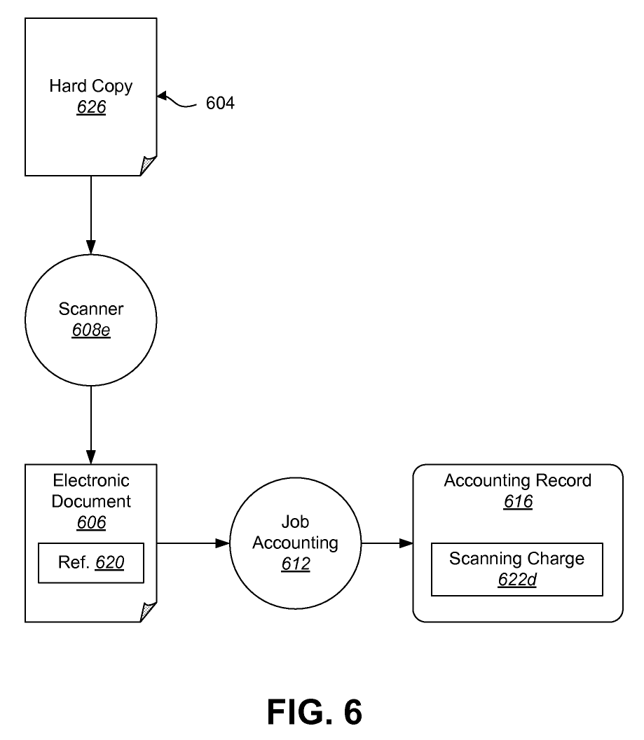

FIG. 6 illustrates the operation of a job accounting system 612 in accordance with an embodiment in response to an imaging job 604 that involves performing at least one imaging operation on a hard copy document 626. In particular, the imaging job 604 involves performing a scanning operation on a hard copy document 626, thereby generating an electronic document 606, which may be in an internal printer ready format (e.g., TIFF, PDF, etc.).

In response to the imaging job 604 being initiated, an accounting record 616 for the imaging job 604 may be created. The accounting record 616 may be uniquely associated with the imaging job 604. For example, a reference 620 to the accounting record 616 may be embedded within the electronic document 606 that is generated by the scanning operation.

In response to the scanning operation being performed, a scanning charge 622d may be applied to the accounting record 616 that is associated with the imaging job 604. (As shown, the electronic document 606 may include a reference 620 to the accounting record 616.) The scanning charge 622d may be based on a standard rate that is defined for the scanning operation.

The scanning operation may be just one of a number of imaging operations that may be performed as part of the imaging job 604, and consequently, the scanning charge 622d may be one charge in an accumulative series of charges. For example, if the imaging job 604 involves making a copy of the document 626, then a printing operation may be performed and a rasterization charge 522b and an outputting charge 522c corresponding to the printing operation may be applied to the accounting record 616. Alternatively, if the imaging job 604 is a “scan to email” job, then an email operation may be performed and an outputting charge 522c corresponding to the email operation may be applied to the accounting record 616. Alternatively still, if the imaging job 604 is an outbound fax job, then a facsimile operation may be performed and an outputting charge 522c corresponding to the facsimile operation may be applied to the accounting record 616.

Also, under some circumstances, the scanning operation may be performed by the user's resources. For example, the user's computer system may host a document scanning service and the imaging device 102 may be configured to utilize the user's document scanning service. The job accounting system 612 may be configured so that no charge is made if the document scanning operation is performed by the user's resources.

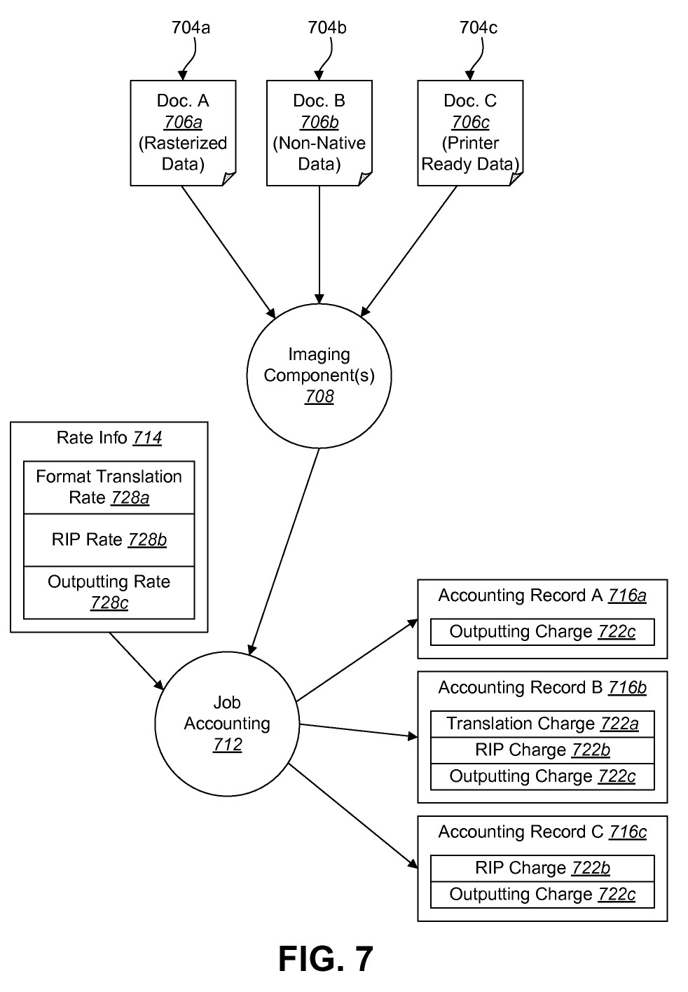

FIG. 7 illustrates an example showing how a job accounting system 712 may process multiple imaging jobs 704a, 704b, 704c in accordance with an embodiment. For purposes of this example, it will be assumed that the first imaging job 704a involves outputting a hard copy of electronic document A 706a (e.g., printing electronic document A 706a), the second imaging job 704b involves outputting a hard copy of electronic document B 706b, and that the third imaging job 704c involves outputting a hard copy of electronic document C 706c. It will also be assumed that electronic document A 706a includes rasterized data, that electronic document B 706b includes non-native data (e.g. application data), and that electronic document C 706c includes printer ready data (e.g., PostScript data). One or more imaging components 708 on the imaging device 102 perform various imaging operations as part of processing the imaging jobs 704a, 704b, 704c.

In the depicted example, a separate standard rate 728 is defined for each imaging operation that may be performed as part of processing an imaging job 704. In particular, a standard rate 728a is defined for a format translation operation. In addition, a standard rate 728b is defined for a rasterization operation. Also, a standard rate 728c is defined for an outputting operation (e.g., printing, faxing, electronic transfer, etc.). This rate information 714 may be utilized by the job accounting system 712 as part of determining and applying charges for imaging jobs 704 that are processed by the imaging device 102.

As mentioned, electronic document A 706a (corresponding to the first imaging job 704a) includes rasterized data. Thus, in order to output a hard copy of electronic document A 706a, only a single imaging operation is performed on electronic document A 706a, namely an outputting operation (e.g., printing). The job accounting system 712 determines that only an outputting operation is performed as part of processing the first imaging job 704a, and consequently applies an outputting charge 722c for the first imaging job 704a. The outputting charge 722c that is applied for the first imaging job 704a is based on the standard rate 728c that is defined for an outputting operation. The outputting charge 722c may be recorded in an accounting record 716a that is uniquely associated with the first imaging job 704a.

As mentioned, electronic document B 706b (corresponding to the second imaging job 704b) includes non-native data (e.g. application data). Thus, in order to output a hard copy of electronic document B 706b, multiple imaging operations are performed on electronic document B 706b, namely a format translation operation, a rasterization operation, and an outputting operation. The job accounting system 712 determines that these operations are performed as part of processing the second imaging job 704b, and consequently applies a format translation charge 722a, a rasterization charge 722b, and an outputting charge 722c for the second imaging job 104. The format translation charge 722a is based on the standard rate 728a that is defined for the format translation operation. Similarly, the rasterization charge 722b is based on the standard rate 728b that is defined for the rasterization operation, and the outputting charge 722c is based on the standard rate 728c that is defined for the outputting operation. The format translation charge 722a, rasterization charge 722b, and outputting charge 722c may be recorded in an accounting record 716b that is uniquely associated with the second imaging job 704b.

As mentioned, electronic document C 706c (corresponding to the third imaging job 704c) includes printer ready data (e.g. PostScript data). Thus, in order to output a hard copy of electronic document C 706c, a rasterization operation and a hardcopy outputting operation are performed on electronic document C 706c. The job accounting system 712 determines that these operations are performed as part of processing the third imaging job 704c, and consequently applies a rasterization charge 722b and a outputting charge 722c for the third imaging job 704c. The rasterization charge 722b is based on the standard rate 728b that is defined for the rasterization operation, and the outputting charge 722c is based on the standard rate 728c that is defined for the outputting operation. The rasterization charge 722b and the outputting charge 722c may be recorded in an accounting record 716c that is uniquely associated with the third imaging job 704c.

In the example that is shown in FIG. 7, the three imaging jobs 704a, 704b, 704c that are processed are all the same type of imaging job 704. In particular, each of the imaging jobs 704a, 704b, 704c involves outputting a hardcopy of an electronic document 706. However, different charges are applied for the different imaging jobs 704a, 704b, 704c, because the different imaging jobs 704a, 704b, 704c involve different imaging operations.

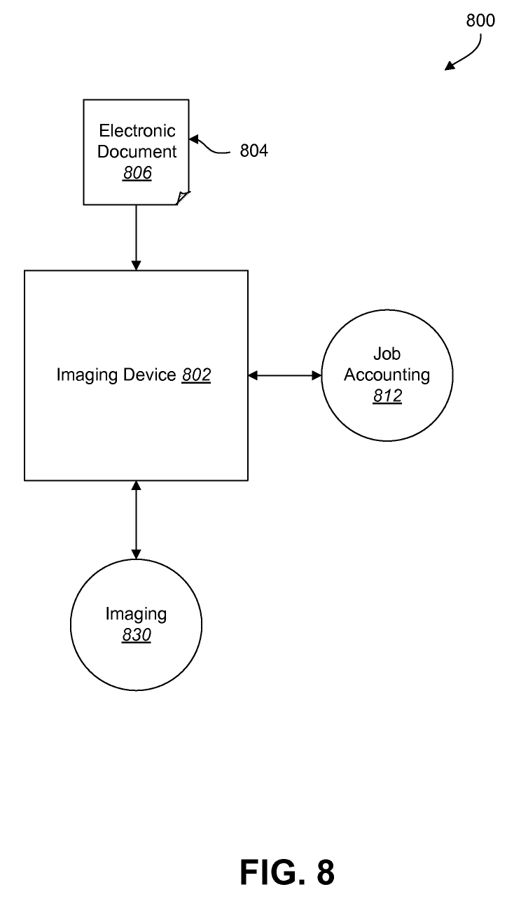

FIG. 8 illustrates another exemplary operating environment 800 in which embodiments may be practiced. The exemplary operating environment 800 includes an imaging device 802 and a job accounting system 812. In the depicted embodiment, the job accounting system 812 may be implemented as a service that is external to the imaging device 802. The job accounting system 812 may otherwise function similarly to one or more of the embodiments described above.

The imaging device 802 may receive and process imaging jobs 804. As discussed above, an imaging job 804 may involve performing one or more imaging operations on an electronic document 806 (or, alternatively, a hard copy document). In the depicted embodiment, when the imaging device 802 processes an imaging job 804, one or more imaging operations may be performed by one or more external imaging services 830, i.e., imaging services 830 that are external to the imaging device 802. Thus, one or more imaging operations within an imaging job 804 may be performed by the imaging device 802, and one or more imaging operations may be performed by an external imaging service 830. Alternatively, all of the imaging operations within an imaging job 804 may be performed by one or more external services 830. Alternatively still, all of the imaging operations within an imaging job 804 may be performed by the imaging device 802.

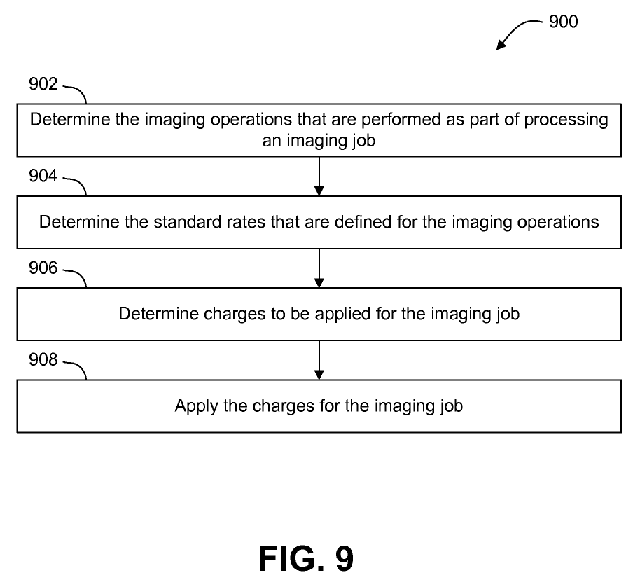

FIG. 9 illustrates a method 900 for unified imaging job accounting in accordance with an embodiment. The method 900 may be performed by a job accounting system 112. As discussed above, the job accounting system 112 may be part of an imaging device 102 that receives and processes imaging jobs 104. Alternatively, the job accounting system 112 may be separate from the imaging device 102. The method 900 may be performed each time an imaging job 104 is processed by an imaging device 102.

The method 900 may involve determining 902 the imaging operations (e.g., format translation, rasterization, hardcopy output, etc.) that are performed as part of processing an imaging job 104. The method 900 may also involve determining 904 the standard rates that are defined for the imaging operations that are performed. The standard rates may be applied across multiple imaging jobs 104 that are processed by the imaging device 102.

The method 900 may also involve determining 906 charges to be applied for the imaging job 104. The charges that are to be applied for the imaging job 104 may be based on the individual imaging operations that are performed as part of processing the imaging job 104, and also based on the standard rates that are defined for these imaging operations.

The method 900 may also involve applying 908 the charges for the imaging job 104. This may involve recording the charges in an accounting record 116 that is uniquely associated with the imaging job 104.

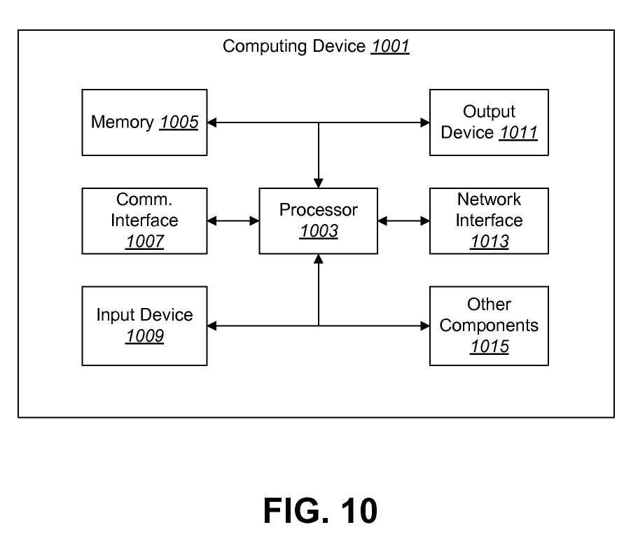

FIG. 10 illustrates various components that may be utilized in a computing device 1001. An imaging device 102 is an example of a computing device 1001. The illustrated components may be located within the same physical structure or in separate housings or structures.

The computing device 1001 may include a processor 1003 and memory 1005. The processor 1003 may control the operation of the computing device 1001 and may be embodied as a microprocessor, a microcontroller, a digital signal processor (DSP) or other device known in the art. The processor 1003 typically performs logical and arithmetic operations based on program instructions stored within the memory 1005. The instructions in the memory 1005 may be executable to implement the methods described herein.

The computing device 1001 may also include one or more communication interfaces 1007 and/or network interfaces 1013 for communicating with other electronic devices. The communication interface(s) 1007 and the network interface(s) 1013 may be based on wired communication technology, wireless communication technology, or both.

The computing device 1001 may also include one or more input devices 1009 and one or more output devices 1011. The input devices 1009 and output devices 1011 may facilitate user input. Other components 1015 may also be provided as part of the computing device 1001.

FIG. 10 illustrates only one possible configuration of a computing device 1001. Various other architectures and components may be utilized.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules, circuits and algorithm steps described in connection with the embodiments disclosed herein may be implemented as electronic hardware, computer software or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as limiting the scope of the claims.

The various illustrative logical blocks, modules and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the embodiments disclosed herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

While specific embodiments have been illustrated and described, it is to be understood that the claims are not limited to the precise configuration and components illustrated above. Various modifications, changes and variations may be made in the arrangement, operation and details of the embodiments described above without departing from the scope of the claims.

What is claimed is:

1. A method for unified imaging job accounting, the method being implemented by a job accounting system, the method comprising:
determining one or more imaging operations that are performed as part of processing the imaging job;
determining standard rates that are defined for the one or more imaging operations, wherein the standard rates are applied across multiple imaging jobs that are processed by the imaging device independent of imaging job type;
determining charges to be applied for the imaging job based on the one or more imaging operations that are performed as part of processing the imaging job and also based on the standard rates that are defined for the one or more imaging operations; and
applying the charges that are determined for the imaging job.

2. The method of claim 1, wherein a separate standard rate is defined for each of the one or more imaging operations.

3. The method of claim 1, wherein a separate charge is applied for each imaging operation that is performed as part of processing the imaging job.

4. The method of claim 1, wherein the method is performed for each imaging job of a plurality of imaging jobs that are processed by the imaging device.

5. The method of claim 1, further comprising applying different charges for different imaging jobs of the same type and same job settings if the different imaging jobs comprise different imaging operations.

6. The method of claim 1, wherein applying the charges for the imaging job comprises recording the charges in an accounting record that is uniquely associated with the imaging job.

7. The method of claim 6, wherein the imaging job comprises a reference to the accounting record that has been created for that imaging job.

8. The method of claim 1, wherein all of the one or more imaging operations are performed by the imaging device.

9. The method of claim 1, wherein at least one of the one or more imaging operations is performed by a service that is external to the imaging device.

10. The method of claim 1, wherein the one or more imaging operations comprise a format translation operation.

11. The method of claim 1, wherein the one or more imaging operations comprise a rasterization operation.

12. The method of claim 1, wherein the one or more imaging operations comprise an outputting operation.

13. The method of claim 1, wherein the one or more imaging operations comprise a scanning operation.

14. The method of claim 1, wherein at least one of the one or more imaging operations of the imaging job is performed on an electronic document.

15. The method of claim 1, wherein at least one of the one or more imaging operations of the imaging job is performed on a hard copy document.

16. The method of claim 1, further comprising not applying any charges for any of the one or more imaging operations that are performed by a user's resources.

17. The method of claim 1, wherein the job accounting system is part of the imaging device.

18. The method of claim 1, wherein the job accounting system is external to the imaging device.

19. A computer system that is configured for unified imaging job accounting, the computer system comprising:
a processor;
memory in electronic communication with the processor; and
instructions stored in the memory, the instructions being executable to:
determine one or more imaging operations that are performed as part of processing the imaging job;
determine standard rates that are defined for the one or more imaging operations, wherein the standard rates are applied across multiple imaging jobs that are processed by the imaging device independent of imaging job type;
determine charges to be applied for the imaging job based on the one or more imaging operations that are performed as part of processing the imaging job and also based on the standard rates that are defined for the one or more imaging operations; and
apply the charges that are determined for the imaging job.

20. A computer-readable medium comprising executable instructions for:
determining one or more imaging operations that are performed as part of processing the imaging job;
determining standard rates that are defined for the one or more imaging operations, wherein the standard rates are applied across multiple imaging jobs that are processed by the imaging device independent of imaging job type;
determining charges to be applied for the imaging job based on the one or more imaging operations that are performed as part of processing the imaging job and also based on the standard rates that are defined for the one or more imaging operations; and
applying the charges that are determined for the imaging job.
